(19) United States
(12) Patent Application Publication
(10) Pub. No.: US 2025/0096696 A1
(43) Pub. Date: Mar. 20, 2025

(54) POWER CONVERSION APPARATUS

(71) Applicant: FUJI ELECTRIC CO., LTD., Kawasaki-shi (JP)

(72) Inventor: Takanori SHINTANI, Suzuka-shi (JP)

(21) Appl. No.: 18/782,032

(22) Filed: Jul. 24, 2024

(30) Foreign Application Priority Data
Sep. 20, 2023 (JP) 2023-152286

(51) Int. Cl. H02M 7/00; H02M 7/537

(52) U.S. Cl. CPC H02M 7/003; H02M 7/537

(57) ABSTRACT

A power conversion apparatus includes a direct current/direct current converter, an inverter arranged at a position facing to the direct current/direct current converter, a capacitor arranged on the inverter side and connected to the direct current/direct current converter, and a first busbar arranged in an electrically insulating housing accommodating the capacitor and configured to serve as wiring for electrically connecting the direct current/direct current converter to the direct current power supply arranged on the inverter side.

### CROSS-REFERENCE TO RELATED APPLICATIONS

The present application is based on, and claims priority from Japanese Patent application number JP 2023-152286 filed on Sep. 20, 2023, the disclosure of which is hereby incorporated by reference herein in its entirety.

### BACKGROUND

### Technical Field

The present disclosure relates to a power conversion apparatus, and particularly to a power conversion apparatus including a direct current/direct current or DC/DC converter and an inverter arranged at position facing the direct current/direct current converter.

### Description of the Background Art

Power conversion apparatuses including a direct current/direct current converter and an inverter arranged at position facing the direct current/direct current converter are known in the art. Such a power conversion apparatus is disclosed in Japanese Patent Laid-Open Publication No. JP 2023-53944, for example.

The power conversion apparatus disclosed in the above Japanese Patent Laid-Open Publication No. JP 2023-53944 includes a direct current/direct current converter, and an inverter. In a configuration disclosed in the above Japanese Patent Laid-Open Publication No. JP 2023-53944, the direct current/direct current converter, and the inverter are arranged at positions facing each other. Also, the above Japanese Patent Laid-Open Publication No. JP 2023-53944 discloses a configuration in which the direct current/direct current converter transforms direct current electric power input from a direct current power supply, and supplies the electric power transformed to the inverter unit.

Although an arrangement of the direct current power supply is not disclosed in the above Japanese Patent Laid-Open Publication No. JP 2023-53944, in a configuration in which the direct current/direct current converter and the inverter are separated from each other by an interposition such as a cooler for cooling the direct current/direct current converter and the inverter, the direct current power supply is arranged on the inverter side in some cases. In such a case, it is difficult to arrange wires that electrically connect the direct current power supply and the direct current/direct current converter, which are separated from each other by the interposition such as the cooler, to each other. On the other hand, it can be conceived that the direct current power supply is electrically connected to the direct current/direct current converter by busbars for the electrical connection as wiring. However, in a case in which the direct current/direct current converter and the inverter are separated from each other by such an interposition, in order to prevent a current flowing from the busbar to the interposition, the busbars are required to be arranged while surely providing electrical insulation of the interposition from the busbars. For this reason, in electrical connection between the direct current power supply and the direct current/direct current converter, which are arranged on one side and another side in the power conversion apparatus and are separated from each other by the interposition, it is desired to easily arrange wiring while surely providing electrical insulation of the interposition.

### SUMMARY

One or more embodiments of the present invention is intended to solve the above problem, and one object of one or more embodiments of the present invention is to provide a power conversion apparatus capable of easily arranging, in electrical connection between a direct current power supply and a direct current/direct current converter that are arranged on one side and another side in the power conversion apparatus and are separated from each other by an interposition, wiring while surely providing electrical insulation of the interposition.

In order to attain the aforementioned object, a power conversion apparatus according to one aspect of the present invention includes a direct current/direct current converter for transforming direct current power input from a direct current power supply; an inverter arranged at a position facing the direct current/direct current converter and configured to convert the direct current power transformed by the direct current/direct current converter into alternating current power to supply the alternating current power to a load; a capacitor arranged on the inverter side and connected to the direct current/direct current converter; and a first busbar arranged in an electrically insulating housing accommodating the capacitor and configured to serve as wiring for electrically connecting the direct current/direct current converter to the direct current power supply arranged on the inverter side.

In the power conversion apparatus according to the aforementioned one aspect of this invention, as discussed above, a first busbar arranged in an electrically insulating housing accommodating a capacitor to serve as wiring for electrically connecting the direct current/direct current converter to the direct current power supply arranged on the inverter side is provided. According to this configuration, because first busbar is arranged in the electrically insulating housing accommodating the capacitor, dissimilar a configuration in which the first busbar is arranged on a non-electrically insulating part, it is possible to arrange the first busbar in the housing without electrically insulating the first busbar while surely providing electrical insulation. Also, because the direct current/direct current converter and the direct current power supply are electrically connected to each other by the first busbar arranged in the housing, it is possible to arrange the direct current power supply and the direct current/direct current converter, which are arranged on one side and another side in the power conversion apparatus and are separated from each other by an interposition. Consequently, it is possible to easily arrange wiring in electrical connection between the direct current power supply and the direct current/direct current converter, which are arranged on one side and another side in the power conversion apparatus and are separated from each other by the interposition, while surely providing electrical insulation of the interposition.

In the power conversion apparatus according to the aforementioned aspect, a cooler arranged between the inverter and the direct current/direct current converter and configured to cool the inverter and the direct current/direct current converter may be further provided; and that the direct current/direct current converter is arranged on one side of the cooler, and the direct current power supply and the inverter are arranged on another side of the cooler. According to this configuration, in a configuration in which the cooler cools the inverter and the direct current/direct current converter arranged at positions facing each other, it is possible to stably arrange the first busbar. Consequently, in the power conversion apparatus cooling the inverter and the direct current/direct current converter arranged at positions facing each other by using the cooler, it is possible to easily arrange wiring while surely providing electrical insulation in electrical connection between the direct current/direct current converter and the direct current power supply.

In this configuration, the housing may be formed of an electrically insulating resin material, and includes a groove on an exterior surface of the housing; and that the first busbar is arranged in the groove. According to this configuration, because the first busbar is arranged in the groove of the housing formed of the electrically insulating resin material, it is possible to easily electrically insulate the first busbar without covering the first busbar with an electrically insulating part.

In the configuration in which the first busbar is arranged in the groove of the housing formed of the electrically insulating resin material, the groove has a groove width greater than a thickness of the first busbar, and includes a contact part on an interior-side surface of the groove in contact with the first busbar. According to this configuration, because the groove width of the groove is greater than the thickness of the first busbar, it is possible to easily arrange the first busbar in the groove. Also, because the contact part on the interior-side surface of the groove in contact with the first busbar is provided, it is possible to prevent positional deviation the first busbar after the first busbar is arranged in the groove. Consequently, it is possible to prevent positional deviation the first busbar while surely providing ease of assembly in arrangement of the first busbar into the groove.

In this configuration, the contact part may include a plurality of contact parts arranged at different positions from each other in an extension direction of the groove on both interior-side surfaces in a width direction of the groove. According to this configuration, because the contact parts are arranged on both sides of the groove in the width direction, and are in contact with the first busbar at different positions from each other in the extension direction of the groove, it is possible to easily and surely prevent positional deviation the first busbar.

In the configuration in which the contact part includes a plurality of contact parts arranged at different positions from each other in an extension direction of the groove on both interior-side surfaces in a width direction of the groove, the groove may be arranged in the housing adjacent to a part of the housing that accommodates the capacitor. According to this configuration, as compared with a configuration in which the groove is formed on an exterior side of the part that accommodates the capacitor, it is possible to prevent increase of a thickness of the housing accommodating the capacitor. As a result, because the housing accommodating the capacitor can be prevented from increasing in size, it is possible to prevent increase of the power conversion apparatus in size.

In this configuration, the direct current power supply may include input terminals arranged on the inverter side; that the first busbar includes a positive busbar electrically connected to a positive terminal of the input terminals, and a negative busbar electrically connected to a negative terminal of the input terminals; and that the groove includes a first groove in which the positive busbar is arranged, and a second groove in which the negative busbar is arranged. According to this configuration, because the positive busbar is arranged in the first groove, and the negative busbar is arranged in the second groove, it is possible to easily electrically insulate the positive busbar and the negative busbar from each other. Consequently, even in a case in which the first busbar includes a plurality of busbars, it is possible to easily electrically insulate the busbars from each other.

In a configuration in which the first busbar includes the positive busbar and the negative busbar, and the groove includes a first groove in which the positive busbar is arranged, and a second groove in which the negative busbar is arranged, the direct current/direct current converter may include a step-down converter for stepping down the direct current power; that an output terminal through which the direct current power stepped down by the step-down converter is output, and a second busbar electrically connected to the output terminal are further provided; and that the groove includes a third groove in which the second busbar is arranged. According to this configuration, it is possible to easily arrange the second busbar while electrically insulating the second busbar in electrical connection between the step-down converter and the output terminal by the second busbar.

In this configuration, the direct current/direct current converter may include a boost converter for boosting the direct current power; that a third busbar electrically connecting the boost converter to the capacitor is further provided; and that the housing includes a third-busbar fixation part to which the third busbar is fixed. According to this configuration, it is possible to arrange not only the first busbars but also the third busbar in the housing accommodating the capacitor. As a result, as compared to a configuration in which the third busbar is arranged at a position different from the housing accommodating the capacitor, it is possible to collectively arrange the third busbar and the first busbars in the housing. Consequently, it is possible to prevent complicated arrangement of the third busbar.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram of a power conversion apparatus according to one embodiment.

FIG. 2 is a perspective view of the power conversion apparatus according to the one embodiment.

FIG. 3 is a side view of the power conversion apparatus according to the one embodiment.

FIG. 4 is an enlarged perspective view of grooves for receiving busbars of the power conversion apparatus according to the one embodiment.

FIG. 5 is a perspective view showing first and second busbars included in the power conversion apparatus according to the one embodiment.

FIG. 6 is a side view showing the first and second busbars included in the power conversion apparatus according to the one embodiment.

FIG. 7 is an enlarged front view of the grooves for receiving the busbars of the power conversion apparatus according to the one embodiment.

FIG. 8 is a top view showing the first and second busbars included in the power conversion apparatus according to the one embodiment.

FIG. 9 is an enlarged top view of the grooves for receiving the busbars of the power conversion apparatus according to the one embodiment.

FIG. 10 is a perspective view showing a housing of a capacitor included in the power conversion apparatus according to the one embodiment with the first and second busbars being arranged and a third busbars being fixed.

### DESCRIPTION OF THE EMBODIMENTS

Embodiments embodying the present invention will be described with reference to the drawings.

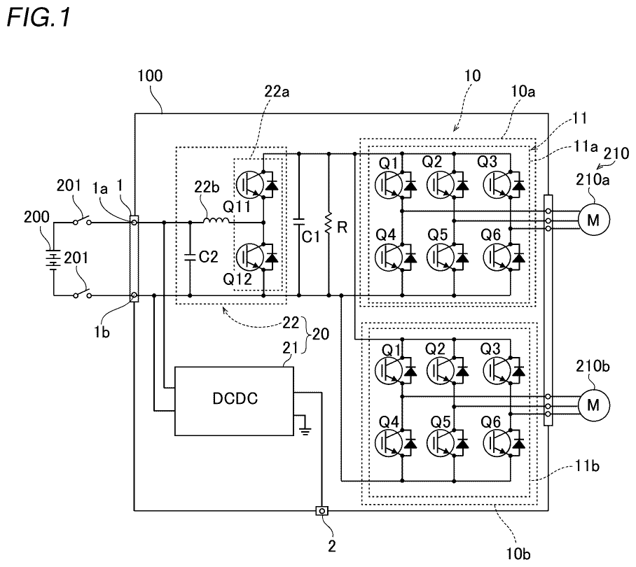

A configuration of a power conversion apparatus 100 according to one embodiment of the present invention will be described with reference to FIGS. 1 to 10. The power conversion apparatus 100, for example, is installed on a vehicle.

A circuit configuration of the power conversion apparatus 100 is first described with reference to FIG. 1. The power conversion apparatus 100 includes input terminals 1 and an output terminal 2. The power conversion apparatus 100 includes an inverter 10, a direct current/direct current or DC/DC converter 20, a capacitor C1, and a direct current power supply 200. Also, the power conversion apparatus 100 includes a resistor R. Also, the power conversion apparatus 100 includes first busbars 60 (see FIG. 5) as wiring for electrically connecting the direct current/direct current converter 20 to the direct current power supply 200.

The inverter 10 is configured to convert direct current power transformed by the direct current/direct current converter 20 into alternate current power, and to supply the alternate current converted to loads 210. The loads 210 are electric motors, for example. Switches 201 are connected between the power conversion apparatus 100 and the direct current power supply 200.

The inverter 10 includes switching element modules 11. The switching element modules 11 convert direct current power into alternating current power. Each switching element module 11 includes semiconductor switching elements Q1, Q2 and Q3 that construct an upper arm, and semiconductor switching elements Q4, Q5 and Q6 that construct a lower arm.

The inverter 10 includes a first inverter 10a and a second inverter 10b. Switching element modules 11 include a first switching element module 11a included in the first inverter 10a, and a second switching element module 11b included in the second inverter 10b. Also, the loads 210 include a first load 210a and a second load 210b. The first inverter 10a converts the direct current power input from the direct current power supply 200 into alternate current power, and supplies the alternate current power to the first load 210a. The second inverter 10b converts the direct current power input from the direct current power supply 200 into alternate current power, and supplies the alternate current power to the second load 210b.

The direct current/direct current converter 20 transforms direct current power input from the direct current power supply 200. In this embodiment, the direct current/direct current converter 20 includes a DCDC converter 21 and a boost converter 22. The DCDC converter 21 is an example of a “step-down converter” in the claims.

The DCDC converter 21 converts a voltage of the direct current power into a different voltage. Specifically, the DCDC converter 21 reduces the voltage of the direct current power input from the direct current power supply 200 through the input terminals 1. Also, the DCDC converter 21 supplies the voltage reduced to the output terminal 2.

The boost converter 22 is arranged on an input side of the inverter 10. The boost converter 22 increases the voltage of the direct current power input from the direct current power supply 200, and to supply the direct current power whose voltage is increased to the inverter 10. The boost converter 22 includes a boost switching element module 22a, and a reactor 22b. The boost switching element module 22a includes boost switching elements Q11 and Q12. The boost switching elements Q11 and Q12 construct the upper and lower arms, respectively. In addition, the boost converter 22 includes a capacitor C2. The reactor 22b is connected between a positive side of the direct current power supply 200, and a connection point between the boost switching element Q11 and the boost switching element Q12. The capacitor C2 is connected in parallel to the boost switching element Q12.

The capacitor C1 is connected to the direct current/direct current converter 20. In this embodiment, the capacitor C1 is connected between the boost converter 22 and the inverter 10. In this embodiment, the resistor R is connected between the boost converter 22 and the inverter 10. The capacitor C1 and the resistor R are connected in parallel to each other.

The direct current power supply 200 includes the input terminal 1 connected to the inverter 10 side. The input terminals 1 include a positive terminal 1a and a negative terminal 1b.

Direct current power that is stepped down by the DCDC converter 21 is output through the output terminal 2. The output terminal 2 is connected to a controller (not shown), or the like.

A structure of the power conversion apparatus 100 is now described.

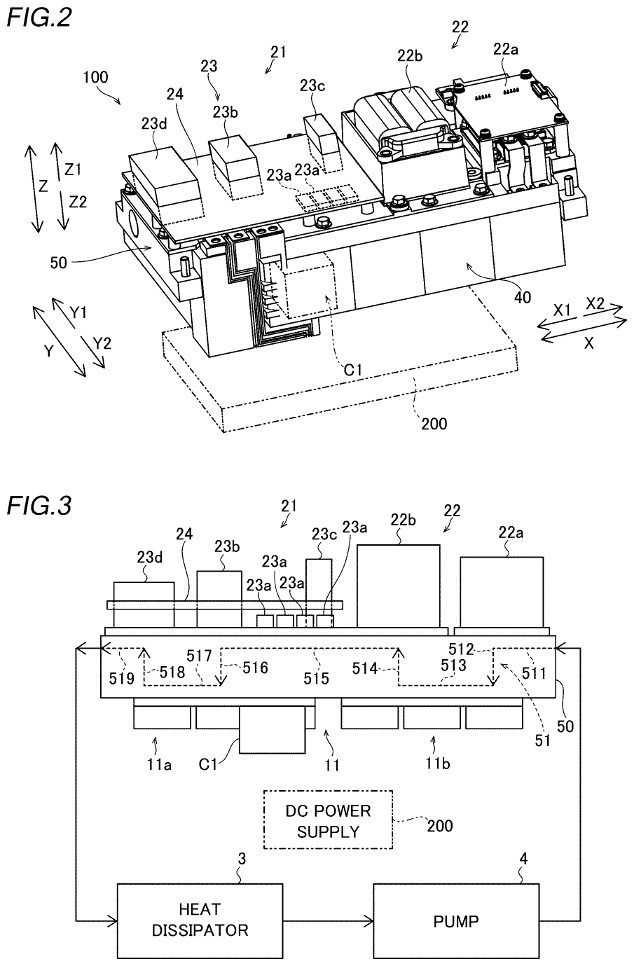

In this embodiment, as shown in FIG. 2, the DCDC converter 21 includes direct current/direct current converter elements 23, and a direct current/direct current converter board 24 on which the direct current/direct current converter elements 23 are mounted. The direct current/direct current converter board 24 has a flat plate-like shape. The direct current/direct current converter elements 23 mounted on the direct current/direct current converter board 24 include converter switching elements 23a, a transformer 23b, a resonant reactor 23c, and a smoothing reactor 23d. In this specification, a frontward/backward direction of the direct current/direct current converter board 24 is defined as a Z direction. A direction from a back side toward a front side of the direct current/direct current converter board 24 is defined as a Z1 direction, while a direction from the front side toward the back side of the direct current/direct current converter board 24 is defined as a Z2 direction in the Z direction. One of two directions orthogonal to the Z direction and to each other is defined as an X direction, and another direction is defined as a Y direction. One direction is defined as an X1 direction, and another direction is defined as an X2 direction in the X direction. One direction is defined as a Y1 direction, and another direction is defined as a Y2 direction in the Y direction.

The converter switching elements 23a are installed on a part on the back side (Z2 direction side) with respect to the direct current/direct current converter board 24. The transformer 23b, the resonant reactor 23c and the smoothing reactor 23d are arranged to pass through the direct current/direct current converter board 24.

Also, as shown in FIG. 2, the power conversion apparatus 100 includes a cooler 50. The cooler 50 has a flat plate-like shape. The cooler 50 is arranged between the inverter 10 (see FIG. 1) and the direct current/direct current converter 20 (see FIG. 1). Also, the cooler 50 is formed of a metal having a relatively high thermal conductivity, such as aluminum, for example. The cooler 50 has a rectangular shape as viewed in a direction orthogonal to a front surface (a surface on the front side (a surface on the Z1 side)) and a back surface (a surface on the back side (a surface on the Z2 side)) of the cooler 50. The cooler 50 includes a cooling flow path 51 (see FIG. 3) through which a cooling liquid flows. In the structure illustratively shown in FIG. 2, the power conversion apparatus 100 is illustrated so that a longitudinal direction of the cooler 50 extends in the X direction, and a shorter direction extends in the Y direction.

In this embodiment, the switching element modules 11 of the inverter 10 (see FIG. 3) are mounted to the cooler 50 so as to extend along the front surface or the back surface of the flat-plate-like cooler 50. Also, the direct current/direct current converter board 24 on which the direct current/direct current converter elements 23 are mounted to the cooler 50 so as to extend along the front surface or the back surface of the flat-plate-like cooler 50.

Specifically, in this embodiment, the switching element modules 11 are mounted to the cooler 50 so as to extend along the back surface of the flat-plate-like cooler 50. That is, the inverter 10 is arranged on the another direction side (Z2 direction side) of the cooler 50. The direct current/direct current converter board 24 on which the direct current/direct current converter elements 23 are mounted is mounted to the cooler 50 so as to extend along the front surface of the flat-plate-like cooler 50.

The DC/DC converter 21 includes capacitor C2 connection terminals connected to a capacitor C2 (see FIG. 1). While inverter output terminal of the first switching element module 11a and the second switching element module 11b are arranged on one of longitudinal-side ends of the cooler 50, the capacitor C2 connection terminals are arranged on another end opposite to at least the one end.

In this embodiment, the boost converter 22 is mounted to the cooler 50 so as to extend along the front surface or the back surface of the flat-plate-like cooler 50. Specifically, the boost converter 22 is mounted to the front surface of the cooler 50. The boost converter 22 is arranged adjacent to the DCDC converter 21 so as to extend in the longitudinal direction (X direction) of the flat-plate-like cooler 50.

In this embodiment, the boost switching element module 22a and the reactor 22b are mounted to the cooler 50 so as to extend along the front surface or the back surface of the flat-plate-like cooler 50. Specifically, the direct current/direct current converter board 24, the reactor 22b, and the boost switching element module 22a are mounted to the cooler 50 so as to extend along the front surface of the flat-plate-like cooler 50 and to be arranged adjacent to each other. The direct current/direct current converter board 24, the reactor 22b, and the boost switching element module 22a are mounted in this order to the front surface of the cooler 50.

Also, as shown in FIG. 2, the condenser C1 is mounted to the cooler 50 so as to extend along the front surface or the back surface of the flat-plate-like cooler 50. Specifically, the condenser C1 is mounted to the back surface of the cooler 50. That is, the capacitor C1 is arranged on the inverter 10 side (Z2 direction side).

As shown in FIG. 2, the direct current power supply 200 is also arranged on the inverter 10 side (Z2 direction side). That is, the direct current power supply 200 is arranged on the another side of the cooler 50 (Z2 direction side). In this embodiment, the direct current power supply 200 is arranged on the inverter 10 side and separated from the direct current/direct current converter 20 by the cooler 5.

As shown in FIG. 3, the cooling flow path 51 is formed so that the cooling liquid alternately passes through the front surface and the back surface of the cooler 50. Specifically, the cooling flow path 51 includes cooling flow paths 511, 515 and 519, which are arranged on the front side (front surface side) as front side flow paths, cooling flow paths 513 and 517, which are arranged on the back side (back surface side) as back side flow paths, and cooling flow paths 512, 514, 516 and 518 as connecting flow paths. The cooling flow path 51 is formed so that the cooling fluid flows into one end of the cooler 50 in the longitudinal (X direction), and the cooling fluid flows out from another end.

The cooling flow paths 511, 512, 513, 514, 515, 516, 517, 518 and 519 in the cooling flow path 51 are connected to each other in this order from an upstream side toward a downstream side. In other words, as shown in FIG. 3, in the cooling flow path 51, the cooling liquid flows into the cooling flow path 511 as the front side flow path through the cooling flow path 512 as the connecting flow path, the cooling flow path 513 as the back side flow path, the cooling flow path 514 as the connecting flow path, the cooling flow path 515 as the front side flow path, the cooling flow path 516 as the connecting flow path, the cooling flow path 517 as the back side flow path and the cooling flow path 518 as the connecting flow path, and then flows out through the cooling flow path 519 as the front side flow path. Alternatively, an inlet through which the cooling liquid flows into the cooling flow path 51 and an outlet through which the cooling liquid flows out of the cooling flow path can be arranged in a central part of the cooler 50 in the shorter direction. According to this arrangement, because positions of the inlet through which the cooling liquid flows into the cooling flow path and the outlet through which the cooling liquid flows out of the cooling flow path are unchanged irrespective of whether the surface on which the DCDC converter 21 is arranged is an upper surface or a lower surface when the power conversion apparatus 100 shown in FIG. 2 is accommodated in customer's machine, the customer does not necessarily change a cooling liquid piping arrangement.

Also, the cooling liquid that flows out of the cooling flow path 51 is cooled by dissipating its heat by using a heat dissipator 3. Also, the cooling liquid that is cooled by the heat dissipator 3 is fed by a pump 4, and flows back into the cooling flow path 51. The heat dissipator 3 includes a heat exchanger to be cooled by outside air. The heat dissipator 3 is a radiator, for example. Alternatively, the pump 4 can be connected between the outlet of the cooling flow path 51 and the heat dissipator 3 so that the cooling liquid before the heat dissipation by the heat dissipator 3 is fed by the pump 4. For example, the cooling liquid is water, antifreeze, or the like.

Also, as shown in FIG. 3, the inverter 10 (see FIG. 1) is arranged on the back surface of the cooler 50. That is, the inverter 10 is arranged on the another direction side (Z2 direction side) of the cooler 50. The inverter 10 is cooled by the cooling liquid flowing through the back side flow paths (cooling flow path 513 and cooling flow path 517). In this embodiment, the first switching element module 11a and the second switching element module 11b are arranged on the back side of the cooler 50, and cooled by the cooling liquid flowing in the back side flow paths.

The DC/DC converter 21 is arranged on the front side of the cooler 50, and is cooled by the cooling liquid flowing through the front side flow paths (cooling flow path 511, cooling flow path 515 and cooling flow path 519) Specifically, the converter switching elements 23a, the transformer 23b, the resonant reactor 23c, and the smoothing reactor 23d are arranged on the front side of the cooler 50, and are cooled by the cooling liquid flowing through the front side flow paths.

The boost converter 22 is arranged on the front side of the cooler 50, and is cooled by the cooling liquid flowing through the front side flow paths (cooling flow path 511, cooling flow path 515 and cooling flow path 519) Specifically, the boost switching element module 22a and the reactor 22b are placed on the front side of the cooler 50, and are cooled by the cooling liquid flowing in the front side flow paths. In this embodiment, the direct current/direct current converter 20 (see FIG. 1) is arranged on one direction side (Z1 direction side) of the cooler 50. In this embodiment, the inverter 10 is arranged at a position facing to the direct current/direct current converter 20.

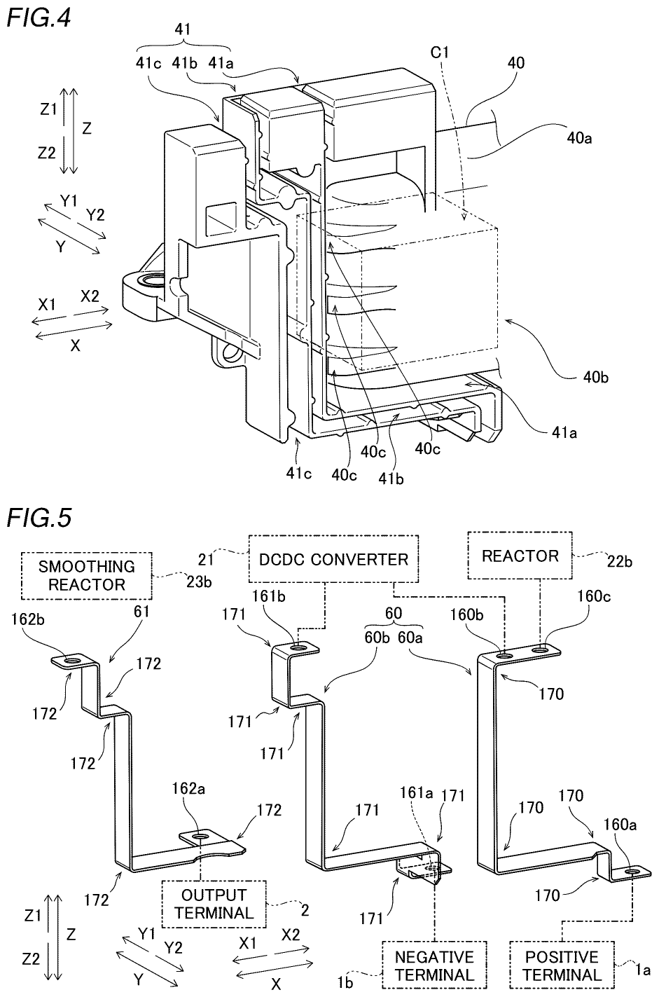

In this embodiment, the first busbars 60 (see FIG. 5) are arranged in grooves 41 (see FIG. 4) of a housing 40 (see FIG. 4) to electrically connect the direct current power supply 200 arranged on the another side (Z2 direction side) of the cooler 50 to the direct current/direct current converter 20 arranged on the one side (Z1 direction side) of the cooler 50.

### (Grooves)

As shown in FIG. 4, the housing 40 is formed of an electrically insulating resin material. Also, the housing 40 has grooves 41 in an exterior surface 40a. In this embodiment, the grooves 41 are arranged in the housing 40 adjacent to a part 40b of the housing 40 that accommodates the capacitor C1. Specifically, the grooves 41 are arranged on a part of the housing 40 on the X1 side with respect to the part 40b, which accommodates the C1 capacitor.

As shown in FIG. 4, the grooves 41 include a plurality of grooves. In this embodiment, the grooves 41 include a first groove 41a, a second groove 41b, and a third groove 41c. The first groove 41a to the third groove 41c are grooves in which a positive busbar 60a (see FIG. 5), a negative busbar 60b (see FIG. 5), and a second busbar 61 (see FIG. 5) are arranged. The first groove 41a to the third groove 41c will be described later.

In addition, a plurality of protrusions 40c is provided at positions facing the first groove 41a of the housing 40. The plurality of protrusions 40c will be described later.

### (First and Second Busbars)

As shown in FIG. 5, the power conversion apparatus 100 (see FIG. 1) includes the first busbars 60 arranged in the electrically insulating housing 40 accommodating the capacitor C1 (see FIG. 1) to serve as wiring for electrically connecting the direct current/direct current converter 20 (see FIG. 1) to the direct current power supply 200 (see FIG. 1) arranged on the inverter 10 (see FIG. 1) side. In this embodiment, the first busbars 60 include the positive busbar 60a and the negative busbar 60b.

The positive busbar 60a is electrically connected to the positive terminal 1a of the input terminals 1 (see FIG. 1). Also, the negative busbar 60b is electrically connected to the negative terminal 1b of input terminal 1.

In addition, the power conversion apparatus 100 includes the second busbar 61 electrically connected to the output terminal 2.

The positive busbar 60a includes a first connection terminal 160a, a second connection terminal 160b, and a third connection terminal 160c. The first connection terminal 160a is arranged on the Z2 side of the positive busbar 60a, and is connected to the positive terminal 1a of the direct current power supply 200. Also, the second connection terminal 160b is arranged on the Z1 side of the positive busbar 60a, and is connected to the positive terminal of the DCDC converter 21. The third connection terminal 160c is also arranged on the Z1 side of the positive busbar 60a, and is connected to the reactor 22b.

Also, as shown in FIG. 5, the positive side busbar 60a includes a plurality of bent parts 170 between the first connection terminal 160a, and the second connection terminal 160b and the third connection terminal 160c. In an exemplary shape in FIG. 5, the positive side busbar 60a includes four bent parts 170.

Also, the negative busbar 60b includes a first connection terminal 161a and a second connection terminal 161b. The first connection terminal 161a is arranged on the Z2 side of the negative busbar 60b, and is connected to the negative terminal 1b of the direct current power supply 200. Also, the second connection terminal 161b is arranged on the Z1 side of the negative busbar 60b, and is connected to the negative terminal of the DCDC converter 21.

Also, as shown in FIG. 5, the negative busbar 60b includes a plurality of bent parts 171 between the first connection terminal 161a and the second connection terminal 161b. In an exemplary shape in FIG. 5, the negative busbar 60b includes six bent parts 171.

Also, the second busbar 61 also includes a first connection terminal 162a and a second connection terminal 162b. The first connection terminal 162a is arranged on the Z2 direction side of the second busbar 61, and is connected to the output terminal 2. The second connection terminal 162b is arranged on the Z1 side of the second busbar 61, and is connected to the smoothing reactor 23d.

Also, as shown in FIG. 5, the second busbar 61 includes a plurality of bent parts 172 between the first connection terminal 162a and the second connection terminal 162b. In an exemplary shape in FIG. 5, the second busbar 61 includes five bent parts 172.

The shape of the positive busbar 60a, the shape of the negative busbar 60b, and the shape of the second busbar 61 shown in FIG. 5 are merely illustrative, and are not limited to the shapes shown in FIG. 5.

### (Relationship Between Groove Widths of Grooves and Thickness of Busbars, and Configuration of Contact Parts)

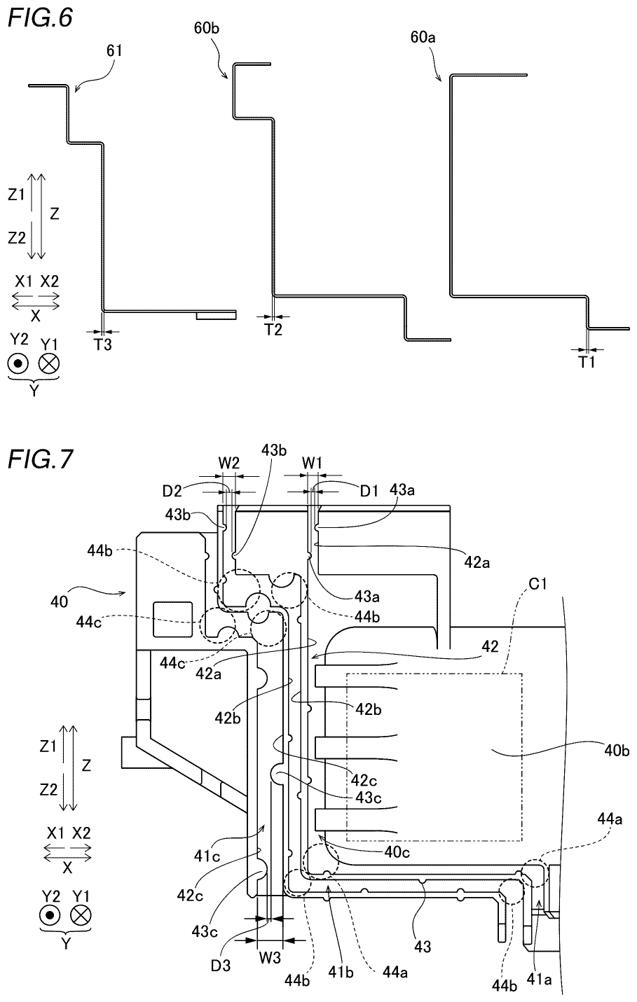

Relationships between thicknesses of the positive busbar 60a (see FIG. 6), the negative busbar 60b (see FIG. 6) and the second busbar 61 (see FIG. 6), and groove widths of the first groove 41a (see FIG. 7) to the third groove 41c (see FIG. 7), and a configuration of contact parts 43 (see FIG. 7) are now described with reference to FIGS. 6 and 7.

As shown in FIG. 6, the positive side busbar 60a has a predetermined thickness T1. Also, the negative busbar 60b has a predetermined thickness T2. Also, the second busbar 61 has a predetermined thickness T3. The thickness T1 of the positive busbar 60a, the thickness T2 of the negative busbar 60b, and the thickness T3 of the second busbar 61 are thicknesses in X direction of the busbars.

In this embodiment, the thickness T1 of the positive busbar 60a, the thickness T2 of the negative busbar 60b, and the thickness T3 of the second busbar 61 are equal to each other. Alternatively, the thickness T1 of the positive busbar 60a, the thickness T2 of the negative busbar 60b, and the thickness T3 of the second busbar 61 can be different from each other.

In this embodiment, the grooves 41 have a groove width greater than the thickness of the first busbars 60, as shown in FIG. 7.

Specifically, a groove width W1 of the first groove 41a in which the positive busbar 60a is arranged (see FIG. 6) is greater than the thickness T1 of the positive busbar 60a (see FIG. 6). Also, a groove width W2 of the second groove 41b in which the negative busbar 60b (see FIG. 6) is arranged is greater than the thickness T2 of the negative busbar 60b (see FIG. 6). Also, a groove width W3 of the third groove 41c in which the second busbar 61 (see FIG. 6) is arranged is greater than the thickness T3 of the second busbar 61 (see FIG. 6).

In addition, as shown in FIG. 7, the groove 41 includes the contact parts 43, which is in contact with the first busbar 60, on interior-side surfaces 42 of the groove 41. In this embodiment, the contact parts 43 include a plurality of contact parts 43 arranged at different positions from each other in an extension direction of the groove 41 on both interior-side surfaces 42 in a width direction (X direction) of the groove 41.

Specifically, as shown in FIG. 7, the first groove 41a includes a plurality of first contact parts 43a arranged at different positions from each other in the extension direction of the first groove 41a on both interior-side surfaces 42a. As shown in FIG. 7, the first contact parts 43a have semicircular shapes in a cross section. In a part in which the first groove 41a extends in the Z direction, the plurality of first contact parts 43a is arranged at different positions from each other in the Z direction on the both interior-side surfaces 42a of the first groove 41a in the X direction. In addition, in a part in which the first groove 41a extends in the X direction, the plurality of first contact parts 43a is arranged at different positions from each other in the X direction on the both interior-side surfaces 42a of the first groove 41a in the Z direction.

Also, as shown in FIG. 7, a distance D1 between the first contact parts 43a facing each other is substantially equal to the thickness T1 of the positive busbar 60a. That is, the positive busbar 60a is held in the first groove 41a by the plurality of first contact parts 43a. Here, the term that the distance D1 between the first contact parts 43a facing each other is substantially equal to the thickness T1 of the positive busbar 60a refers to that the distance D1 between the first contact parts 43a facing each other is a distance that allows the first contact parts 43a facing each other to hold the positive busbar 60a. Specifically, the distance D1 between the first contact parts 43a facing each other is slightly smaller than the thickness T1 of the positive busbar 60a. Accordingly, the positive busbar 60a can be securely held by pressing the positive busbar 60a into the first groove 41a (positions between the first contact parts 43a facing each other) by using the first contact parts 43a facing each other.

In addition, the first groove 41a has a plurality of bent parts 44a. Specifically, the first groove 41a has the plurality of bent parts 44a so that the positive side busbar 60a can be arranged in the first groove.

Also, the second groove 41b includes a plurality of second contact parts 43b arranged at different positions from each other in an extension direction of the second groove 41b on both interior-side surfaces 42b. As shown in FIG. 7, the second contact parts 43b have semicircular shapes in a cross section. In a part in which the second groove 41b extends in the Z direction, the plurality of second contact parts 43b is arranged at different positions from each other in the Z direction on the both interior-side surfaces 42b of the second groove 41b in the X direction. Also, in a part in which the second groove 41b extends in the X direction, the plurality of second contact parts 43b is arranged at different positions from each other in the X direction on the both interior-side surfaces 42b of the second groove 41b in the Z direction.

Also, as shown in FIG. 7, the distance D2 between the second contact parts 43b facing each other is substantially equal to the thickness T2 of the negative busbar 60b. That is, the negative busbar 60b is held in the second groove 41b by the plurality of second contact parts 43b. Here, the term that the distance D2 between the second contact parts 43b facing each other is substantially equal to the thickness T2 of the negative busbar 60b refers to that the distance D2 between the second contact parts 43b facing each other is a distance that allows the second contact parts 43b facing each other to hold the negative busbar 60b. Specifically, the distance D2 between the second contact parts 43b facing each other is slightly smaller than the thickness T2 of the negative busbar 60b. Accordingly, the negative busbar 60b can be securely held by pressing the negative busbar 60b into the second groove 41b (positions between the second contact parts 43b facing each other) by using the second contact parts 43b facing each other.

In addition, the second groove 41b has a plurality of bent parts 44b. Specifically, the second groove 41b has the plurality of bent parts 44b so that the negative busbar 60b can be arranged in the second groove.

Also, the third groove 41c includes a plurality of third contact parts 43c arranged at different positions from each other in an extension direction of the third groove 41c on both interior-side surfaces 42c. As shown in FIG. 7, the third contact parts 43c have semicircular shapes in a cross section. In a part in which the third groove 41c extends in the Z direction, the plurality of third contact parts 43c is arranged at different positions from each other in the Z direction on the both interior-side surfaces 42c of the third groove 41c in the X direction. Also, in a part in which the third groove 41c extends in the X direction, the plurality of third contact parts 43c is arranged at different positions from each other in the X direction on the both interior-side surfaces 42c of the third groove 41c in the Z direction.

Also, as shown in FIG. 7, the distance D3 between the third contact parts 43c facing each other is substantially equal to the thickness T3 of the second busbar 61. That is, the second busbar 61 is held in the third groove 41c by the plurality of third contact parts 43c. Here, the term that the distance D3 between the third contact parts 43c facing each other is substantially equal to the thickness T3 of the second busbar 61 refers to that the distance D3 between the third contact parts 43c facing each other is a distance that allows the third contact parts 43c facing each other to hold the second busbar 61. Specifically, the distance D3 between the third contact parts 43c facing each other is slightly smaller than the thickness T3 of the second busbar 61. Accordingly, the second busbar 61 can be securely held by pressing the second busbar 61 into the third groove 41c (positions between the third contact parts 43c facing each other) by using the third contact parts 43c facing each other.

In addition, the third groove 41c has a plurality of bent parts 44c. Specifically, the third groove 41c has the plurality of bent parts 44c so that the second busbar 61 can be arranged in the third groove.

Also, as shown in FIG. 7, the part 40b, which accommodates the capacitor C1, of the housing 40 has the plurality of protrusions 40c protruding in the X1 direction. The plurality of protrusion 40c is arranged at positions different in the Z direction from the plurality of first contact parts 43a arranged on the interior-side surface 42a of the first groove 41a on the X1 direction side. That is, the plurality of protrusions 40c serves as the contact parts 43 of the first groove 41a on the X2 direction side.

### (Relationships Between Widths of Busbars and Depths of Grooves)

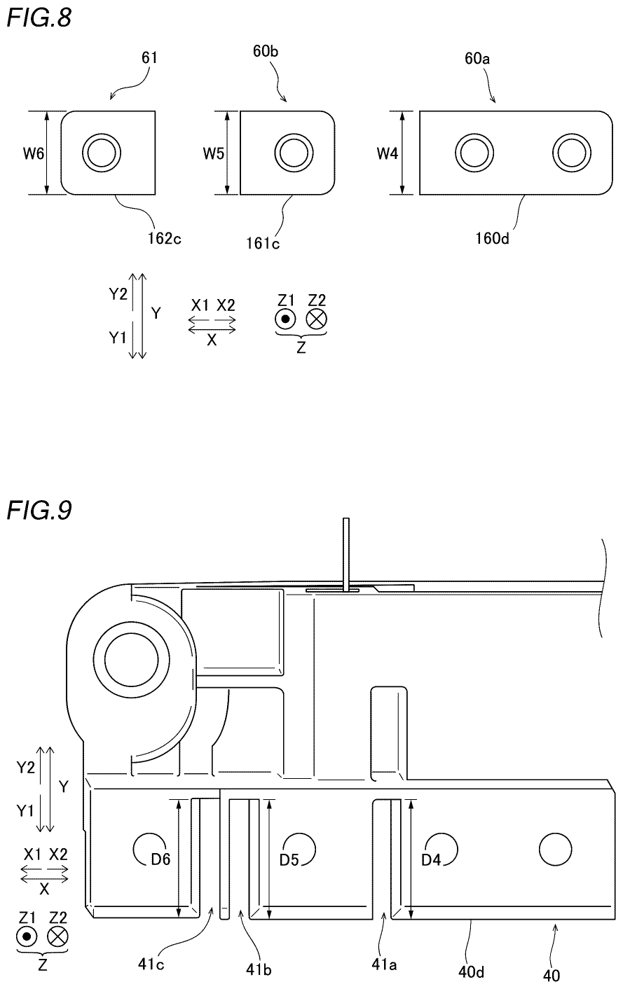

Relationships between widths of the positive busbar 60a (see FIG. 8), the negative busbar 60b (see FIG. 8) and the second busbar 61 (see FIG. 8), and depths of the first groove 41a (see FIG. 9) to the third groove 41c (see FIG. 9) are now described with reference to FIGS. 8 and 9.

As shown in FIG. 8, the positive side busbar 60a has a predetermined width W4. Also, the negative busbar 60b has a predetermined width W5. Also, the second busbar 61 has a predetermined width W6. The width W4 of the positive busbar 60a, the width W5 of the negative busbar 60b, and the width W6 of the second busbar 61 are widths of the busbars in Y direction.

In this embodiment, as shown in FIG. 8, the width W4 of the positive busbar 60a, the width W5 of the negative busbar 60b, and the width W6 of the second busbar 61 are equal to each other. Alternatively, the width W4 of the positive busbar 60a, the width W5 of the negative busbar 60b, and the width W6 of the second busbar 61 can be different from each other.

As shown in FIG. 9, the first groove 41a has a depth D4 greater than the width W4 (see FIG. 8) of the positive busbar 60a (see FIG. 8). Also, the second groove 41b has a depth D5 greater than the width W5 (see FIG. 8) of the negative busbar 60b (see FIG. 8). Also, the third groove 41c has a depth D6 greater than the width W5 (see FIG. 8) of the second busbar 61 (see FIG. 8). The depth D4 of the first groove 41a, the depth D5 of the second groove 41b, and the depth D6 of the third groove 41c are lengths of the grooves 41 in the Y direction.

Because the depth D4 of the first groove 41a is greater than the width W4 of the positive busbar 60a, when the positive busbar 60a is arranged in the first groove 41a, a position of an end 160d of the positive busbar 60a on the Y1 direction side (see FIG. 8) is positioned on the interior side (Y2 direction side) with respect to an end 40d of the housing 40 on the Y1 direction side. That is, the first groove 41a can receive the positive busbar 60a inside the first groove 41a in the Y direction.

Because the depth D5 of the second groove 41b is greater than the width W5 of the negative busbar 60b, when the negative busbar 60b is arranged in the second groove 41b, a position of an end 161c of the negative busbar 60b on the Y1 direction side (see FIG. 8) is positioned on the interior side (Y2 direction side) with respect to an end 40d of the housing 40 on the Y1 direction side. That is, the second groove 41b can receive the negative busbar 60b inside the second groove 41b in the Y direction.

Because the depth D6 of the third groove 41c is greater than the width W6 of the second busbar 61, when the second busbar 61 is arranged in the third groove 41c, a position of an end 162c of the second busbar 61 on the Y1 direction side (see FIG. 8) is positioned on the interior side (Y2 direction side) of the third groove 41c. That is, the third groove 41c can receive the second busbar 61 inside the third groove 41c in the Y direction.

Because the positive busbar 60a, the negative busbar 60b, and the second busbar 61 can be independently arranged inside the groove 41, which is provided in the electrically insulating housing 40, in the Y direction, the busbars can be individually arranged with being electrically insulated in the housing without applying electrical insulation treatment to the individual busbars.

### (Arrangement of Busbar in Housing)

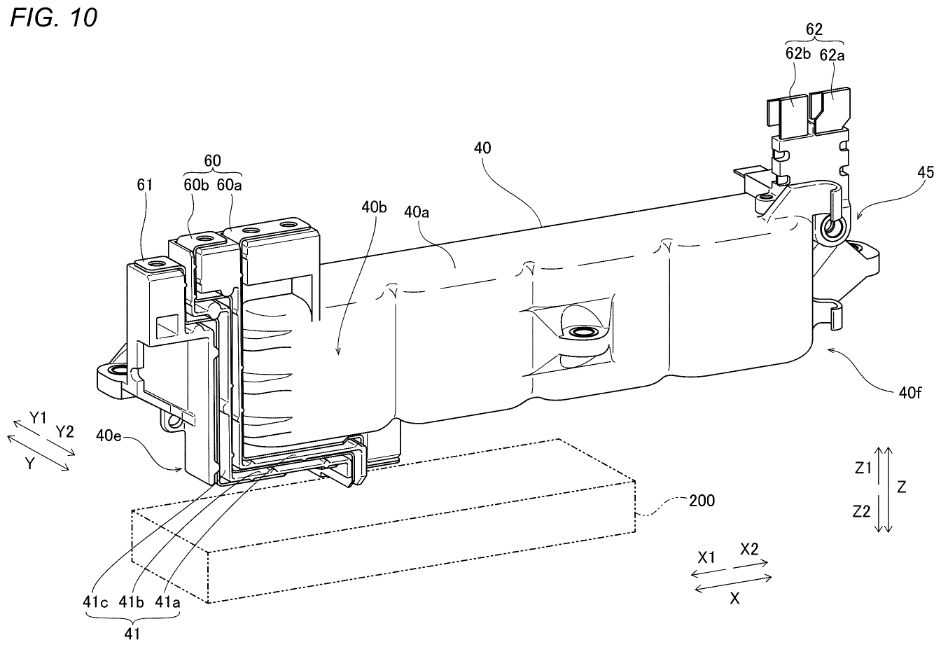

In this embodiment, as shown in FIG. 10, the positive busbar 60a, the negative busbar 60b, and the second busbar 61 are arranged in the first groove 41a, the second groove 41b, and the third groove 41c, respectively, with being separated from each other in the X direction in the housing 40. In this embodiment, the positive busbar 60a, the negative busbar 60b, and the second busbar 61 are arranged in this order from the X2 direction side in the grooves 41. The positive busbar 60a, the negative busbar 60b, and the second busbar 61 are arranged side by side on an end 40e of the housing 40 on the X1 direction side.

In addition, as shown in FIG. 10, the power conversion apparatus 100 includes a third busbars 62 for electrically connecting the boost converter 22 (see FIG. 1) to the capacitor C1 (see FIG. 1). In addition, the housing 40 has a third-busbar fixation part 45 to which the third busbars 62 are fixed. In this embodiment, the third busbars 62 include a third positive busbar 62a and a third negative busbar 62b. The third positive busbar 62a is connected to a positive terminal of the capacitor C1. The third negative busbar 62b is connected to a negative terminal of the capacitor C1.

In this embodiment, the third-busbar fixation part 45 is arranged on an end 40f of the housing 40 on the X2 direction side. Accordingly, the third busbar 62 is fixed to the end 40f of the housing 40 on the X2 direction side. The third busbars 62 are fixed to the third-busbar fixation part 45 by screws, for example. Alternatively, the third busbar 62 can be fixed to the third-busbar fixation part 45 by a means other than screwing.

### Advantages of the Embodiments

In this embodiment, the following advantages are obtained.

As described above, a power conversion apparatus 100 according to this embodiment includes a direct current/direct current converter 20 for boosting the direct current power input from the direct current power supply 200; an inverter 10 arranged at a position facing the direct current/direct current converter 20 and configured to convert the direct current power transformed by the direct current/direct current converter 20 into alternating current power to supply the alternating current power to a load 210; a capacitor C1 arranged on the inverter 10 side and connected to the direct current/direct current converter 20; and first busbars 60 arranged in an electrically insulating housing 40 accommodating the capacitor C1 and configured to serve as wiring for electrically connecting the direct current/direct current converter 20 to the direct current power supply 200 arranged on the inverter 10 side.

In this embodiment, as described above, the first busbars 60 arranged in the electrically insulating housing 40 accommodating the capacitor C1 and configured to serve as wiring for electrically connecting the direct current/direct current converter 20 to the direct current power supply 200 arranged on the inverter 10 side is provided. Accordingly, because the first busbars 60 are arranged in the electrically insulating housing 40 accommodating the capacitor C1, dissimilar a configuration in which the first busbars 60 are arranged on a non-electrically insulating part, it is possible to arrange the first busbars 60 in the housing 40 without electrically insulating the first busbars 60 while surely providing electrical insulation. Also, because the direct current/direct current converter 20 and the direct current power supply 200 are electrically connected to each other by the first busbars 60 arranged in the housing 40, it is possible to arrange the direct current power supply 200 and the direct current/direct current converter 20, which are arranged on one side and another side in the power conversion apparatus 100 and are separated from each other by an interposition. Consequently, it is possible to easily arrange wiring in electrical connection between the direct current power supply 200 and the direct current/direct current converter 20, which are arranged on one side and another side in the power conversion apparatus 100 and are separated from each other by the interposition, while surely providing electrical insulation of the interposition.

In this embodiment, as described above, a cooler 50 arranged between the inverter 10 and the direct current/direct current converter 20 and configured to cool the inverter 10 and the direct current/direct current converter 20 is further provided; and the direct current/direct current converter 20 is arranged on one side of the cooler 50, and the direct current power supply 200 and the inverter 10 are arranged on another side of the cooler 50. Accordingly, in a configuration in which the cooler 50 cools the inverter 10 and the direct current/direct current converter 20 arranged at positions facing each other, it is possible to easily arrange the first busbars 60. Consequently, in the power conversion apparatus 100 cooling the inverter 10 and the direct current/direct current converter 20 arranged at positions facing each other by using the cooler 50, it is possible to easily arrange wiring while surely providing electrical insulation in electrical connection between the direct current/direct current converter 20 and the direct current power supply 200.

In this embodiment, as described above, the housing 40 is formed of an electrically insulating resin material, and includes grooves 41 on an exterior surface 40a of the housing; and the first busbars 60 are arranged in the grooves 41. Accordingly, because the first busbars 60 are arranged in the grooves 41 of the housing 40 formed of the electrically insulating resin material, it is possible to easily electrically insulate the first busbars 60 without covering the first busbars 60 with an electrically insulating part.

In this embodiment, as described above, the grooves 41 have a groove width greater than a thickness of the first busbars 60, and include contact parts 43 on interior-side surfaces 42 of the grooves 41 in contact with the first busbars 60. According to this configuration, because the groove width of the grooves 41 is greater than the thickness of the first busbars 60, it is possible to easily arrange the first busbars 60 in the grooves 41. Also, because the contact parts 43 on the interior-side surfaces 42 of the grooves 41 in contact with the first busbars 60 are provided, it is possible to prevent positional deviation the first busbars 60 after the first busbars 60 are arranged in the grooves 41. Consequently, it is possible to prevent positional deviation the first busbars 60 while surely providing ease of assembly in arrangement of the first busbars 60 into the grooves 41.

In this embodiment, as described above, the contact parts 43 include a plurality of contact parts 43 arranged at different positions from each other in an extension direction of the groove 41 on both interior-side surfaces 42 in a width direction (X direction) of the groove 41. Accordingly, because the contact parts 43 are arranged on both sides of the groove 41 in the width direction, and are in contact with the first busbar 60 at different positions from each other in the extension direction of the groove 41, it is possible to easily and surely prevent positional deviation the first busbar 60.

In this embodiment, as described above, the grooves 41 are arranged in the housing 40 adjacent to a part 40b of the housing 40 that accommodates the capacitor C1. According to this configuration, as compared with a configuration in which the grooves 41 are formed on an exterior side of the part 40b that accommodates the capacitor C1, it is possible to prevent increase of a thickness of the housing 40 accommodating the capacitor C1. As a result, because the housing 40 accommodating the capacitor C1 can be prevented from increasing in size, it is possible to prevent increase of the power conversion apparatus 100 in size.

In this embodiment, as described above, the direct current power supply 200 includes input terminals 1 arranged on the inverter 10 side; the first busbars 60 include a positive busbar 60a electrically connected to a positive terminal 1a of the input terminals 1, and a negative busbar 60b electrically connected to a negative terminal 1b of the input terminals 1; and the grooves 41 include a first groove 41a in which the positive busbar 60a is arranged, and a second groove 41b in which the negative busbar 60b is arranged. Accordingly, because the positive busbar 60a is arranged in the first groove 41a, and the negative busbar 60b is arranged in the second groove 41b, it is possible to easily electrically insulate the positive busbar 60a and the negative busbar 60b from each other. Consequently, even in a case in which the first busbars 60 include a plurality of busbars, it is possible to easily electrically insulate the busbars from each other.

In this embodiment, as described above, the direct current/direct current converter 20 includes a DCDC converter 21 for stepping down the direct current power; an output terminal 2 through which the direct current power stepped down by the DCDC converter 21 is output, and a second busbar 61 electrically connected to the output terminal 2 are further provided; and the grooves 41 include a third groove 41c in which the second busbar 61 is arranged. According to this configuration, it is possible to easily arrange the second busbar 61 while electrically insulating the second busbar 61 in electrical connection between the DCDC converter 21 and the output terminal 2 by the second busbar 61.

In this embodiment, as described above, the direct current/direct current converter 20 includes a boost converter 22 for boosting the direct current power; a third busbar 62 electrically connecting the boost converter 22 to the capacitor C1 is further provided; and the housing 40 includes a third-busbar fixation part 45 to which the third busbar 62 is fixed. According to this configuration, it is possible to arrange not only the first busbars 60 but also the third busbar 62 in the housing 40 accommodating the capacitor C1. As a result, as compared to a configuration in which the third busbar 62 is arranged at a position different from the housing 40 accommodating the capacitor C1, it is possible to collectively arrange the third busbar 62 and the first busbars 60 in the housing 40. Consequently, it is possible to prevent complicated arrangement of the third busbar 62.

### MODIFIED EMBODIMENTS

Note that the embodiment disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

While the example in which the housing 40 is formed of an electrically insulating resin material has been shown in the aforementioned embodiment, the present invention is not limited to this. For example, alternatively, the housing can be formed by a material other than the resin material as long as it is electrically insulating. For example, the housing can be made of a metal if electrical insulation treatment is applied to a part in contact with the first busbar.

While the example in which the housing 40 has grooves 41, and the first busbars 60 are arranged in the grooves 41 has been shown in the aforementioned embodiment, the present invention is not limited to this. For example, alternatively, the housing can have no groove. In this case, the housing can be configured to hold the first busbars 60 on its exterior surface. However, in a case in which the housing is configured to hold the first busbars 60 on its exterior surface, the first busbars 60 are necessarily electrically insulated by applying electrical insulation treatment to the first busbars 60, by covering the first busbars 60 with an electrically insulating material, or by other technique. For this reason, the housing 40 preferably has the grooves 41.

While the example in which the grooves 41 have a groove width greater than the thickness of the first busbars 60, and include contact parts 43 on interior-side surfaces 42 of the grooves 41 has been shown in the aforementioned embodiment, the present invention is not limited to this. Alternatively, the grooves can have no contact part on the interior-side surfaces. In this case, the groove width of the grooves can be substantially equal to the thickness of the first busbars 60. However, in a case in which the groove width of the grooves is substantially equal to the thickness of the first busbars 60, ease of assembly is reduced in arrangement of the first busbars 60 into the grooves. For this reason, the grooves 41 may have a groove width greater than the thickness of the first busbars 60, and include the contact parts 43 on the interior-side surfaces 42.

While the example in which each groove 41 includes a plurality of contact parts 43 arranged at different positions from each other in an extension direction of each groove 41 on both interior-side surfaces 42 in a width direction of the groove 41 has been shown in the aforementioned embodiment, the present invention is not limited to this. For example, alternatively, the groove can have a single contact part on its interior-side surface. However, in a case in which the groove has a single contact part, it is difficult to prevent positional deviation the first busbar 60 in some cases after the first busbar 60 is arranged in the groove. For this reason, the groove 41 may include a plurality of contact parts 43 arranged at different positions from each other in an extension direction of the groove 41 on both interior-side surfaces 42 in a width direction of the groove 41.

While the example in which the first busbars 60 include the positive busbar 60a and the negative busbar 60b, and the grooves 41 include a first groove 41a in which the positive busbar 60a is arranged and a second groove 41b in which the negative busbar 60b is arranged has been shown in the aforementioned embodiment, the present invention is not limited to this. For example, alternatively, the grooves can include only one groove in which the positive busbar 60a and the negative busbar 60b are arranged. However, in a case in which the positive busbar 60a and the negative busbar 60b are arranged in only one groove, the positive busbar 60a and the negative busbar 60b are necessarily arranged without the positive busbar 60a and the negative busbar 60b being contact with each other. In this case, ease of assembly is reduced in arrangement of the positive busbar 60a and the negative busbar 60b into the grooves. For this reason, the grooves 41 may include the first groove 41a in which the positive busbar 60a is arranged, and the second groove 41b in which the negative busbar 60b is arranged.

While the example in which the direct current/direct current converter 20 includes the DCDC converter 21, and the power conversion apparatus 100 includes the second busbar 61 electrically connecting the DCDC converter 21 to the output terminal 2 has been shown in the aforementioned embodiment, the present invention is not limited to this. For example, in a case in which the direct current/direct current converter 20 does not include the DCDC converter 21, the power conversion apparatus can include no second busbar 61. The number of busbars included in the power conversion apparatus 100 can be changed depending on a circuit configuration of the power conversion apparatus 100.

While the example in which the power conversion apparatus 100 includes a cooler 50 arranged between an inverter 10 and a direct current/direct current converter 20 to cool the inverter 10 and the direct current/direct current converter 20 has been shown in the aforementioned embodiment, the present invention is not limited to this. For example, alternatively, the power conversion apparatus can include no cooler 50. However, in a case in which the power conversion apparatus does not include the cooler 50, the inverter 10 and the direct current/direct current converter 20 are not cooled, and as a result power conversion efficiency decreases. For this reason, the power conversion apparatus 100 may include the cooler 50.

While the example in which the direct current/direct current converter 20 includes the boost converter 22, and the power conversion apparatus 100 includes the third busbar 62 electrically connecting the boost converter 22 to the capacitor C1 has been shown in the aforementioned embodiment, the present invention is not limited to this. For example, in a case in which the direct current/direct current converter 20 does not include the boost converter 22, the power conversion apparatus can include no third busbar 62. The number of busbars included in the power conversion apparatus 100 can be changed depending on a circuit configuration of the power conversion apparatus 100.

While the example in which the direct current/direct current converter 20 is arranged on the Z1 direction side, and the inverter 10 and the capacitor C1 are arranged on the Z2 direction side has been shown in the aforementioned embodiment, the present invention is not limited to this. For example, alternatively, the direct current/direct current converter 20 can be arranged on the Z2 direction side, and the inverter 10 and the capacitor C1 can be arranged on the Z1 direction side.

What is claimed is:

1. A power conversion apparatus comprising:
a direct current/direct current converter for transforming direct current power input from a direct current power supply;
an inverter arranged at a position facing the direct current/direct current converter and configured to convert the direct current power transformed by the direct current/direct current converter into alternating current power to supply the alternating current power to a load;
a capacitor arranged on the inverter side and connected to the direct current/direct current converter; and
a first busbar arranged in an electrically insulating housing accommodating the capacitor and configured to serve as wiring for electrically connecting the direct current/direct current converter to the direct current power supply arranged on the inverter side.

2. The power conversion apparatus according to claim 1 further comprising a cooler arranged between the inverter and the direct current/direct current converter and configured to cool the inverter and the direct current/direct current converter, wherein
the direct current/direct current converter is arranged on one side of the cooler, and the direct current power supply and the inverter are arranged on another side of the cooler.

3. The power conversion apparatus according to claim 2, wherein
the housing is formed of an electrically insulating resin material, and includes a groove on an exterior surface of the housing; and
the first busbar is arranged in the groove.

4. The power conversion apparatus according to claim 3, wherein the groove has a groove width greater than a thickness of the first busbar, and includes a contact part on an interior-side surface of the groove in contact with the first busbar.

5. The power conversion apparatus according to claim 4,
wherein the contact part includes a plurality of contact parts arranged at different positions from each other in an extension direction of the groove on both interior-side surfaces in a width direction of the groove.

6. The power conversion apparatus according to claim 5, wherein the groove is arranged in the housing adjacent to a part of the housing that accommodates the capacitor.

7. The power conversion apparatus according to claim 6, wherein
the direct current power supply includes input terminals arranged on the inverter side;
the first busbar includes a positive busbar electrically connected to a positive terminal of the input terminals, and a negative busbar electrically connected to a negative terminal of the input terminals; and
the groove includes a first groove in which the positive busbar is arranged, and a second groove in which the negative busbar is arranged.

8. The power conversion apparatus according to claim 7, wherein
the direct current/direct current converter includes a step-down converter for stepping down the direct current power;
the power conversion apparatus further comprises an output terminal through which the direct current power stepped down by the step-down converter is output, and
a second busbar electrically connected to the output terminal; and
the groove includes a third groove in which the second busbar is arranged.

9. The power conversion apparatus according to claim 8, wherein
the direct current/direct current converter includes a boost converter for boosting the direct current power;
the power conversion apparatus further comprises a third busbar electrically connecting the boost converter to the capacitor; and
the housing includes a third-busbar fixation part to which the third busbar is fixed.
